(19) United States
(12) Patent Application Publication
(10) Pub. No.: US 2009/0059451 A1
(43) Pub. Date: Mar. 5, 2009

(54) ESD PROTECTION CIRCUIT WITH IMPROVED COUPLING CAPACITOR

(75) Inventors: Jun Shi, Hebei Province (CN); Cheng-Lien Wang, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HEJIAN TECHNOLOGY (SUZHOU) CO., LTD., Suzhou (CN)

(21) Appl. No.: 11/849,373

(22) Filed: Sep. 4, 2007

(51) Int. Cl. H02H 9/04; H02H 9/00

(52) U.S. Cl. 361/56

(57) ABSTRACT

In an ESD protection circuit, a MOS transistor and a coupling capacitor are formed over the same substrate. The coupling capacitor may be a MIM capacitor or a PIP capacitor. In case of MIM capacitor, the first metal layer and the second metal layer thereof are electrically coupled to the gate region and the source/drain region of the MOS transistor, respectively. In case of PIP capacitor, the gate region of the MOS transistor, an insulation layer and the second poly layer thereof define the PIP capacitor. The second poly layer of the PIP capacitor is electrically coupled to the source/drain region of the MOS transistor.

### BACKGROUND OF THE INVENTION

1. Field of Invention

The present invention relates to a semiconductor structure. More particularly, the present invention relates to an ESD protection circuit with MIM (metal-insulation-metal) or PIP (poly-insulation-poly) improved coupling capacitor.

2. Description of Related Art

In modern integrated circuits usually a huge number of individual circuit elements, such as field effect transistors, capacitors, resistors and the like are formed on a small substrate area so as to provide for the required functionality of the circuitry. Typically, a number of contact pads are provided, which in turn, are electrically connected to respective terminals, also referred to as pins, to allow the circuitry to communicate with the environment. As feature sizes of the circuit elements are steadily shrinking to increase package density and enhance the performance of the integrated circuit, the ability for withstanding an externally applied over voltage to any of the pins of the integrated circuit decreases significantly. One reason for this resides in the fact that decreasing feature sizes of field effect transistors, i.e. reducing the channel length of the field effect transistor, typically requires to also scale down the thickness of the insulation layer separating the gate electrode from the channel region. Any over voltage supplied to a thin gate insulation layer, however, will lead to defects in the gate insulation layer, resulting in a reduced reliability, or may even completely destroy the elements, possibly resulting in a complete failure of the integrated circuit.

One major source of such over voltages is so-called electrostatic discharge (ESD) events, wherein an object carrying charges is brought into contact with some of the pins of the integrated circuit. For example, a person can develop very high static voltage from a few hundred to several thousand volts, merely by moving across a carpet, so that an integrated circuit may be damaged when the person contacts the integrated circuit, for example, by removing the integrated circuit from the corresponding circuit board. A corresponding over voltage caused by an ESD event may even occur during the manufacturing of the integrated circuit and may thus lead to a reduced product yield. Moreover, nowadays there is an increasing tendency to use replaceable ICs in electronic systems so that only one or more integrated circuits have to be replaced in stead of the whole circuit board in order to, for example, upgrade microprocessors and memory cards. Since the reinstallation of replacement integrated circuits is not necessarily carried out by a skilled person in an ESD-safe environment, the integrated circuits have to be provided with corresponding ESD protection. To this end, a number of protective circuits have been proposed that are typically arranged between a terminal of the integrated circuit and the internal circuit to provide a current path ensuring that the voltage applied to the internal circuit remains well below a specified critical limit. For example, in a typical ESD event caused by a charge carrying person, a voltage of several thousand volts is discharged in a time interval of about 100 ns (nanoseconds), thereby creating a current of several amperes. Thus, the ESD protection circuit must allow a current flow of at least several amperes so as to ensure that the voltage across the ESD protection circuit does not exceed the critical limit.

Diodes, gate-grounded MOS transistors, gate-coupled MOS transistors or SCR (silicon-controlled rectifier) may be used in typical ESD protection circuits. Circuitry designs of MOS transistors are easier and have better ESD protection performance.

However, the ESD protections circuits manufactured by sub-micron or deep sub-micron semiconductor processes have lowered ESD protection performance. For increasing ESD protection in CMOS circuitry, the MOS transistors in the ESD protection circuits may have large size. However, during ESD event, not all MOS transistors in the ESD protection circuit will be turn-on concurrently due to the layout location and wirings of the MOS transistors in the ESD protection circuit. For example, in ESD event, in the beginning, maybe a part of MOS transistors are turned on while others not. If so, the ESD currents will flow through just those turned-on MOS transistors but not through turned-off MOS transistors. Therefore, even large size MOS transistors have been used in the ESD protection circuits, the ESD protection circuits still have unsatisfactory ESD performance.

In order to prevent non-current conducting of large size MOS transistors, gate-coupled MOS transistors may be used. FIGS. 1 and 2 show two kinds of conventional RC-triggered active MOS transistor ESD clamp circuits. The clamp circuit provides a current shunt to protect internal circuit for VDD-to-VSS or IC pin (belonging to circuitry protected by the ESD clamp circuit) to VDD/VSS. These known ESD protection circuits involve use of a transistor controlled by a resistance-capacitance (RC) circuit for shunting the flow of ESD current between the protected bond pad and a power supply pad (e.g., VSS). In FIGS. 1 and 2, GCMOS (gate-coupled MOS) are used as the primary ESD protection. Usage of GCMOSs results in lower triggered voltage in ESD events, more concurrent turn-on of GCMOSs in the ESD protection circuits and better ESD performance.

As shown in FIG. 1, the ESD protection circuit at least includes a resistive element R1, a coupling capacitor C1 and a gate-coupled PMOS transistor P1. The drain of the PMOS transistor P1 is connected to VSS (or the IC pin), while the source of the PMOS transistor P1 is connected to VDD. The gate of the PMOS transistor P1 is coupled to VDD via the resistive element R1 and to VSS (or the IC pin) by the coupling capacitor C1.

As shown in FIG. 2, the ESD protection circuit at least includes a resistive element R2, a coupling capacitor C2 and a gate-coupled NMOS transistor N2. The drain of the NMOS transistor N2 is connected to VDD (or IC pin), while the source of the NMOS transistor N2 is connected to VSS. The gate of the NMOS transistor N2 is coupled to VDD (or the IC pin) via the coupling capacitor C2 and to VSS by the resistive element R2.

In the RC-triggered active MOS transistor ESD clamp circuits, the resistance values of the resistive elements and the capacitance values of the coupling capacitors are preferred to be optimized, so that in normal operation, the GCMOSs are all kept OFF while in ESD events, the GCMOSs are all ON.

There are two kinds of coupling capacitors used in ESD protection circuits, parasitic capacitor Cgd and MOS capacitor Cgg. The parasitic capacitor Cgd, an internal parasitic capacitor of MOS transistor, has small capacitance and is subjected to process drift or process variations. Therefore, it is difficult to precisely simulate the capacitance value of the parasitic capacitor Cgd during circuitry designs. The MOS capacitor Cgg has large capacitance value and is stable to process drift or process variations. But the ESD protection circuits using the MOS capacitor Cgg usually have large circuit area and high cost because the MOS capacitor Cgg occupies circuit area.

Therefore, it is preferred to have new ESD protection circuits preventing the above and/or other prior art problems and/or advantages.

### SUMMARY OF THE INVENTION

The invention provides an ESD protection circuit which has MIM (metal-insulation-metal) coupling capacitors or PIP (poly-insulation-poly) coupling capacitors with stable unit capacitance value.

The invention provides an ESD protection circuit, wherein capacitance values of the coupling capacitors and the trigger voltage of the ESD protection circuits may be adjusted via adjusting layout area of MIM coupling capacitors or PIP coupling capacitors.

The invention provides an ESD protection circuit having MIM coupling capacitors or PIP coupling capacitors integrated with the MOS transistor on the same substrate. Therefore, the ESD protection circuit has reduced circuit area.

The invention provides an ESD protection circuit whose ESD performance may be improved by adjusting capacitance values of MIM coupling capacitors or PIP coupling capacitors.

The invention provides an ESD protection structure, comprising: a substrate; an active element, formed over the substrate, the active element having a gate region and a source/drain region; and an MIM or PIP coupling capacitor, formed over the substrate. The MIM or PIP coupling capacitor includes: a first conductive layer, being electrically coupled to the gate region of the active element; a second conductive layer, being electrically coupled to the source/drain region of the active element; and an insulation layer, being intermediate between the first conductive layer and the second conductive layer.

The invention also provides another ESD protection structure, comprising: a substrate; an active element, formed over the substrate, the active element having a gate region and a source/drain region; a second poly layer, formed over the substrate, the second poly layer being electrically coupled to the source/drain region of the active element; and an insulation layer, being intermediate between the gate region of the active element and the second poly layer. The gate region of the active element, the insulation layer and the second poly layer define a PIP coupling capacitor.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 show two kinds of conventional RC-triggered active MOS transistor ESD clamp circuits.

FIG. 3 shows a MOS transistor ESD clamp circuit having an MIM capacitor as a coupling capacitor according to a first embodiment of the invention.

FIG. 4 shows a MOS transistor ESD clamp circuit having a PIP capacitor as a coupling capacitor according to a second embodiment of the invention.

FIG. 5 shows a MOS transistor ESD clamp circuit having a PIP capacitor as a coupling capacitor according to a third embodiment of the invention.

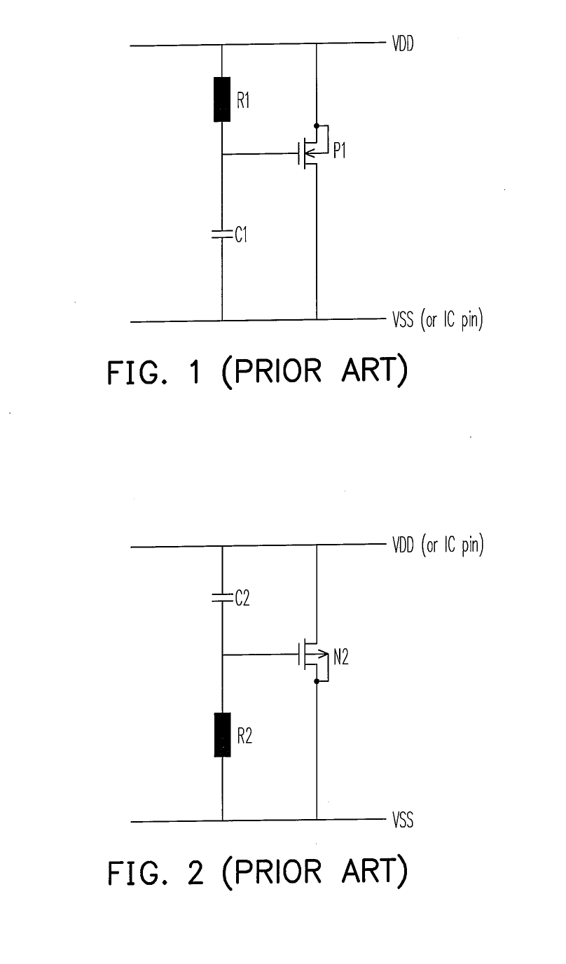

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In embodiments of the invention, in order to prevent problems and/or disadvantages caused by parasitic capacitors and by MOS capacitors, MIM (metal-insulator-metal) capacitors or PIP (poly-insulator-poly) capacitors are used as coupling capacitors in MOS transistor ESD clamp circuits.

### First Embodiment

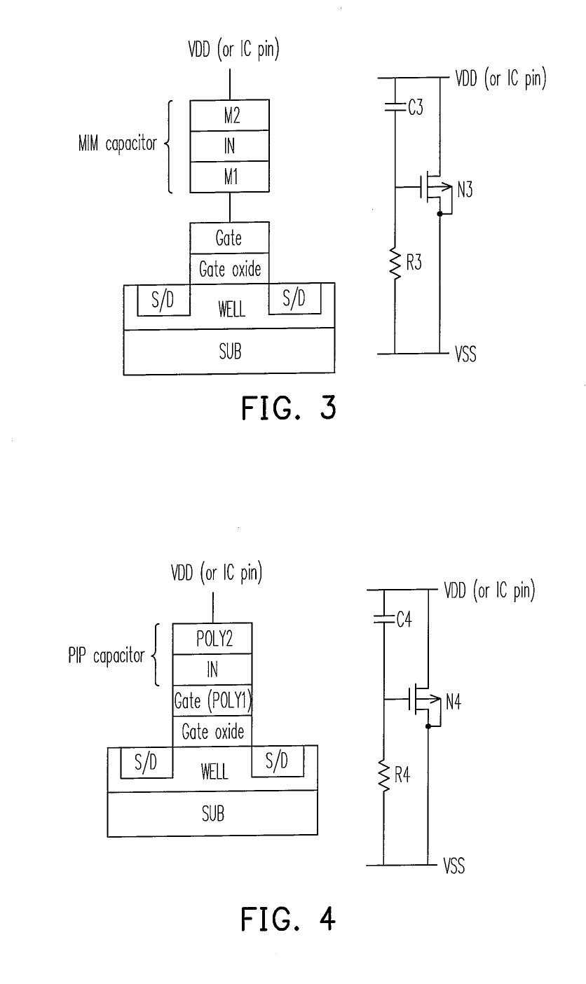

FIG. 3 shows a MOS transistor ESD clamp circuit having an MIM capacitor as a coupling capacitor according to a first embodiment of the invention. As shown in FIG. 3, the ESD protection circuit according to the first embodiment of the invention at least includes a resistive element R3, a coupling capacitor (MIM capacitor) C3 and a gate-coupled NMOS transistor N3. The MIM capacitor C3 and the gate-coupled NMOS transistor N3 are formed over a substrate SUB, for example, a p-type substrate. The drain of the NMOS transistor N3 is connected to VDD (or IC pin), while the source of the NMOS transistor N3 is connected to VSS. The gate of the NMOS transistor N3 is coupled to VDD (or the IC pin) via the coupling capacitor C3 and to VSS by the resistive element R3.

The partially sectional views of the MIM capacitor C3 and the gate-coupled NMOS transistor N3 are also shown in FIG. 3. The gate-coupled NMOS transistor N3 at least includes gate region, gate oxide and source/drain (S/D) region. The source/drain (S/D) region is formed in a well structure WELL, for example, a p-type well. The MIM capacitor C3 at least includes a first metal layer M1, an insulation layer IN and a second metal layer M2. The first metal layer M1 is electrically coupled to gate region (poly gate) of the NMOS transistor N3, for example, through vias or interconnections. The second metal layer M2 is electrically coupled to source/drain (S/D) region of the NMOS transistor N3, or to VDD or to IC pin for example, through vias or interconnections.

For simplicity, the insulation layer IN of FIG. 3 just has one layer. However, people skilled in this art should know that the insulation layer IN is not limited by just one insulation layer. For example, the insulation layer IN may includes several insulation layers, and/or further several metal layers, and/or several poly layers, as long as the intermediate several metal layers and/or several poly layers are not electrically coupled to the metal layers M1, M2, the gate region of the NMOS transistor N3 and the S/D region of the NMOS transistor N3.

### Second Embodiment

FIG. 4 shows a MOS transistor ESD clamp circuit having a PIP capacitor as a coupling capacitor according to a second embodiment of the invention. As shown in FIG. 4, the ESD protection circuit according to the second embodiment of the invention at least includes a resistive element R4, a coupling capacitor (PIP capacitor) C4 and a gate-coupled NMOS transistor N4. The PIP capacitor C4 and the gate-coupled NMOS transistor N4 are formed over a substrate SUB, for example, a p-type substrate. The drain of the NMOS transistor N4 is connected to VDD (or IC pin), while the source of the NMOS transistor N4 is connected to VSS. The gate of the NMOS transistor N4 is coupled to VDD (or the IC pin) via the coupling capacitor C4 and to VSS by the resistive element R4.

The partially sectional views of the PIP capacitor C4 and the gate-coupled NMOS transistor N4 are also shown in FIG. 4. The gate-coupled NMOS transistor N4 at least includes gate region POLY1, gate oxide and source/drain (S/D) region. The source/drain (S/D) region is formed in a well structure WELL, for example, a p-type well. The PIP capacitor C4 at least includes a first poly layer PLOY1, an insulation layer IN and a second poly layer POLY2. The first poly layer POLY1 is the poly gate of the NMOS transistor N4. The coupling capacitor C4 is a parasitic capacitor formed between layers POLY1 and POLY2. The second poly layer POLY2 is electrically coupled to the source/drain (S/D) region of the NMOS transistor N4, or to VDD or to IC pin, for example, through vias or interconnections.

For simplicity, the insulation layer IN of FIG. 4 just has one layer. However, people skilled in this art should know that the insulation layer IN is not limited by just one insulation layer. For example, the insulation layer IN may includes several insulation layers, and/or further several metal layers, and/or several poly layers, as long as the intermediate several metal layers and/or several poly layers are not electrically coupled to the poly layers POLY1, POLY2, the gate region of the NMOS transistor N4 and the S/D region of the NMOS transistor N4.

The second embodiment is applicable in dual-poly process.

### Third Embodiment

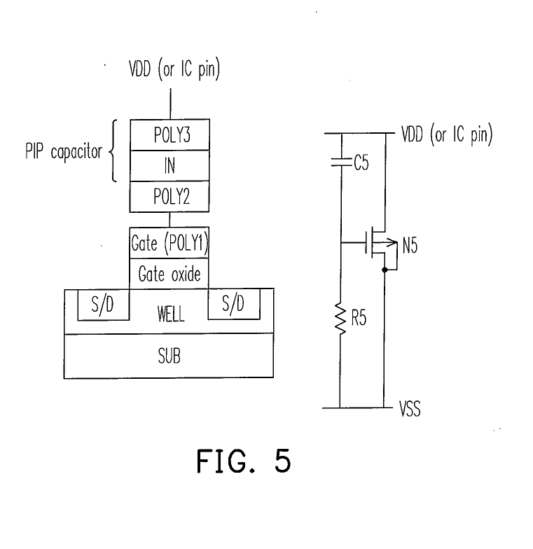

FIG. 5 shows a MOS transistor ESD clamp circuit having a PIP capacitor as a coupling capacitor according to a third embodiment of the invention. As shown in FIG. 5, the ESD protection circuit according to the third embodiment of the invention at least includes a resistive element R5, a coupling capacitor (PIP capacitor) C5 and a gate-coupled NMOS transistor N5. The PIP capacitor C5 and the gate-coupled NMOS transistor N5 are formed over a substrate SUB, for example, a p-type substrate. The drain of the NMOS transistor N5 is connected to VDD (or IC pin), while the source of the NMOS transistor N5 is connected to VSS. The gate of the NMOS transistor N5 is coupled to VDD (or the IC pin) via the coupling capacitor C5 and to VSS by the resistive element R5.

The partially sectional views of the PIP capacitor C5 and the gate-coupled NMOS transistor N5 are also shown in FIG. 5. The gate-coupled NMOS transistor N5 at least includes a poly gate region POLY1, gate oxide and source/drain (S/D) region. The source/drain (S/D) region is formed in a well structure WELL, for example, a p-type well. The PIP capacitor C5 at least includes a poly layer PLOY2, an insulation layer IN and another poly layer POLY3. The poly layer POLY2 of the PIP capacitor C5 is electrically coupled to the poly gate region POLY1 of the NMOS transistor N5. The coupling capacitor C5 is a capacitor formed between layers POLY2 and POLY3. The poly layer POLY3 is electrically coupled to the source/drain (S/D) region of the NMOS transistor N5, or to VDD or to IC pin, for example, through vias or interconnections.

For simplicity, the insulation layer IN of FIG. 5 just has one layer. However, people skilled in this art should know that the insulation layer IN is not limited by just one insulation layer. For example, the insulation layer IN may includes several insulation layers, and/or further several metal layers, and/or several poly layers, as long as the intermediate several metal layers and/or several poly layers are not electrically coupled to the poly layers POLY2, POLY3, the gate region of the NMOS transistor N5 and the S/D region of the NMOS transistor N5.

The third embodiment is applicable in multi-poly process.

Although in the above embodiments, NMOS transistors are shown as examples, the invention is not limited by this. For example, PMOS transistors may be used in the ESD protection circuits, which is still within the scope and spirit of the invention.

However, people skilled in this art should know that the structure of the MOS transistors would not limit the invention, as long as the coupling capacitor is electrically coupled to the MOS transistor through for example vias and/or interconnections.

In summary, the embodiments of the invention at least have following advantages:

(1) MIM capacitors or PIP capacitors have stable unit capacitance value. Therefore, it is easy to precisely simulate capacitance values during circuitry design.

(2) The capacitance value of the coupling capacitor and the trigger voltage of the ESD protection circuits may be adjusted via adjusting layout area of MIM capacitors or PIP capacitors. Therefore, the ESD protection circuits have improved ESD performance.

(3) Usage of MIM capacitors or PIP capacitors would not increase circuit area of the ESD protection circuits because MIM capacitors or PIP capacitors are integrated with the MOS transistor on the same substrate.

(4) ESD performance by the ESD protection circuits may be improved by adjusting the capacitance value of the coupling capacitor. The adjustment of the capacitance value of the coupling capacitor just involves one mask adjustment. It is easy to implement. Therefore, the designers may take less time and less cost on designing and/or adjusting the coupling capacitors and the ESD protection circuits.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An ESD protection structure, comprising:
a substrate;
an active element, formed over the substrate, the active element having a gate region and a source/drain region; and
a coupling capacitor, formed over the substrate, the coupling capacitor having:
a first conductive layer, being electrically coupled to the gate region of the active element;
a second conductive layer, being electrically coupled to the source/drain region of the active element; and
an insulation layer, being intermediate between the first conductive layer and the second conductive layer.

2. The ESD protection structure of claim 1, further comprising:
a resistive element, electrically coupled to the active element and the coupling capacitor.

3. The ESD protection structure of claim 1, wherein the first conductive plate is a first metal layer.

4. The ESD protection structure of claim 3, wherein the second conductive plate is a second metal layer.

5. The ESD protection structure of claim 4, wherein the coupling capacitor is a MIM capacitor.

6. The ESD protection structure of claim 1, wherein the second conductive plate is electrically coupled to a power supply voltage.

7. The ESD protection structure of claim 1, wherein the second conductive plate is electrically coupled to a pin of circuitry protected by the ESD protection structure.

8. The ESD protection structure of claim 1, wherein the active element is a MOS transistor.

9. The ESD protection structure of claim 1, wherein the first conductive plate is a first ploy layer.

10. The ESD protection structure of claim 9, wherein the second conductive plate is a second poly layer.

11. The ESD protection structure of claim 10, wherein the coupling capacitor is a PIP capacitor.

12. An ESD protection structure, comprising:
a substrate;
an active element, formed over the substrate, the active element having a gate region and a source/drain region;
a second poly layer, formed over the substrate, the second poly layer being electrically coupled to the source/drain region of the active element; and
an insulation layer, being intermediate between the gate region of the active element and the second poly layer;
wherein the gate region of the active element, the insulation layer and the second poly layer define a PIP coupling capacitor.

13. The ESD protection structure of claim 12, further comprising:
a resistive element, electrically coupled to the active element and the PIP coupling capacitor.

14. The ESD protection structure of claim 12, wherein the active element is a MOS transistor.

15. The ESD protection structure of claim 12, wherein the second poly layer is electrically coupled to a power supply voltage.

16. The ESD protection structure of claim 12, wherein the second poly layer is electrically coupled to a pin of circuitry protected by the ESD protection structure.
